(19) United States
(12) Patent Application Publication
(10) Pub. No.: US 2024/0129005 A1
(43) Pub. Date: Apr. 18, 2024

(54) METHODS, APPARATUSES, AND COMPUTER READABLE MEDIA FOR PRECODING IN MULTIPLE-INPUT MULTIPLE-OUTPUT SYSTEM BASED ON ARRAY OF SUBARRAY ARCHITECTURE

(71) Applicant: NOKIA SOLUTIONS AND NETWORKS OY, Espoo (FI)

(72) Inventor: Zhihang LI, Shanghai (CN)

(21) Appl. No.: 18/276,070

(22) PCT Filed: May 17, 2021
(86) PCT No.: PCT/CN2021/094044

§ 371 Date: Aug. 7, 2023

(51) Int. Cl. H04B 7/0456; H04B 7/06

(52) U.S. Cl. CPC H04B 7/0465; H04B 7/0686

(57) ABSTRACT

Disclosed are methods for precoding in a downlink multiple-input multiple-output system based on an array of subarray architecture. An example method may include: determining an analog precoding matrix for a plurality of radio frequency chains in the downlink multiple-input multiple-output system; determining a digital precoding matrix for the plurality of radio frequency chains based on the determined analog precoding matrix; and performing a hybrid precoding for a plurality of downlink data streams based on the determined digital precoding matrix and the determined analog precoding matrix. Related apparatuses and computer readable media are also disclosed.

### TECHNICAL FIELD

Various example embodiments relate to methods, apparatuses, and computer readable media for precoding in a multiple-input multiple-output (MIMO) system based on an array of subarray (AoSA) architecture.

### BACKGROUND

In a telecommunication system such as a sixth-generation mobile network or a sixth-generation wireless system after new radio (NR or 5G) system, Terahertz (THz) band with ultra-broad bandwidth may be used for a rapid growth of wireless data rates. A MIMO (for example, a massive MIMO or a multiple-user MIMO) solution may be utilized in such telecommunication system with ultra-short wavelength, for example to achieve better multiplexing gains, better diversity gains, improved energy efficiency, and so on, where a base station may be configured with a large number of antennas. Precoding may be applied to process downlink signals in a MIMO system, where for example channel status information (CSI) of the transmitter of the downlink signals may be unitized to transform modulated symbol streams to data streams suitable for current channels and signal energy may be focused to target users.

### SUMMARY

In a first aspect, disclosed is a method precoding in a downlink multiple-input multiple-output system based on an array of subarray architecture. The method may include: determining an analog precoding matrix for a plurality of radio frequency chains in the downlink multiple-input multiple-output system; determining a digital precoding matrix for the plurality of radio frequency chains based on the determined analog precoding matrix; and performing a hybrid precoding for a plurality of downlink data streams based on the determined digital precoding matrix and the determined analog precoding matrix.

In some example embodiments, the determination of the analog precoding matrix may include: for a radio frequency chain of the plurality of radio frequency chains, determining a column of the analog precoding matrix corresponding to the radio frequency chain in at least one iteration based on a plurality of physical channels associated with the downlink multiple-input multiple-output system and a switch matrix in the downlink multiple-input multiple-output system.

In some example embodiments, in a current iteration of the at least one iteration, the determination of the analog precoding matrix may include: determining a first approximation of an inverse of a Hessian matrix of a first objective function for the current iteration; determining angles of departure corresponding to the column based on the first approximation; and determining a second approximation of an inverse of a Hessian matrix of a second objective function for a next iteration of the at least one iteration through matrix plus and multiplication operations based on the first approximation, a phase difference between the current iteration and the next iteration, and a gradient difference between the current iteration and the next iteration.

In some example embodiments, the determination of the analog precoding matrix may include: for a radio frequency chain of the plurality of radio frequency chains, determining a column of the analog precoding matrix corresponding to the radio frequency chain in at least one iteration based on a subset of a predetermined analog precoding matrix.

In some example embodiments, a carrier frequency of the downlink multiple-input multiple-output system is at or above Terahertz level.

In a second aspect, disclosed is an apparatus for precoding in a downlink multiple-input multiple-output system based on an array of subarray architecture. The apparatus may include: a plurality of transmitting antennas; a plurality of radio frequency chains; an analog precoder between the plurality of radio frequency chains and the plurality of transmitting antennas; and a digital precoder connecting to the plurality of radio frequency chains. An analog precoding matrix associated with the analog precoder is determined independently of a digital precoding matrix associated with the digital precoder, and the digital precoding matrix is determined based on the determined analog precoding matrix.

In some example embodiments, the determination of the analog precoding matrix may include: for a radio frequency chain of the plurality of radio frequency chains, determining a column of the analog precoding matrix corresponding to the radio frequency chain in at least one iteration based on a plurality of physical channels associated with the downlink multiple-input multiple-output system and a switch matrix in the downlink multiple-input multiple-output system.

In some example embodiments, in a current iteration of the at least one iteration, the determination of the analog precoding matrix may include: determining a first approximation of an inverse of a Hessian matrix of a first objective function for the current iteration; determining angles of departure corresponding to the column based on the first approximation; and determining a second approximation of an inverse of a Hessian matrix of a second objective function for a next iteration of the at least one iteration through matrix plus and multiplication operations based on the first approximation, a phase difference between the current iteration and the next iteration, and a gradient difference between the current iteration and the next iteration.

In some example embodiments, the determination of the analog precoding matrix may include: for a radio frequency chain of the plurality of radio frequency chains, determining a column of the analog precoding matrix corresponding to the radio frequency chain in at least one iteration based on a subset of a predetermined analog precoding matrix.

In some example embodiments, a carrier frequency of the downlink multiple-input multiple-output system is at or above Terahertz level.

In a third aspect, disclosed is a computer readable medium. The computer readable medium may include instructions stored thereon for causing an apparatus for precoding in a downlink multiple-input multiple-output system based on an array of subarray architecture to perform: determining an analog precoding matrix for a plurality of radio frequency chains in the downlink multiple-input multiple-output system; determining a digital precoding matrix for the plurality of radio frequency chains based on the determined analog precoding matrix; and performing a hybrid precoding for a plurality of downlink data streams based on the determined digital precoding matrix and the determined analog precoding matrix.

In some example embodiments, the determination of the analog precoding matrix may include: for a radio frequency chain of the plurality of radio frequency chains, determining a column of the analog precoding matrix corresponding to the radio frequency chain in at least one iteration based on a plurality of physical channels associated with the downlink multiple-input multiple-output system and a switch matrix in the downlink multiple-input multiple-output system.

In some example embodiments, in a current iteration of the at least one iteration, the determination of the analog precoding matrix may include: determining a first approximation of an inverse of a Hessian matrix of a first objective function for the current iteration; determining angles of departure corresponding to the column based on the first approximation; and determining a second approximation of an inverse of a Hessian matrix of a second objective function for a next iteration of the at least one iteration through matrix plus and multiplication operations based on the first approximation, a phase difference between the current iteration and the next iteration, and a gradient difference between the current iteration and the next iteration.

In some example embodiments, the determination of the analog precoding matrix may include: for a radio frequency chain of the plurality of radio frequency chains, determining a column of the analog precoding matrix corresponding to the radio frequency chain in at least one iteration based on a subset of a predetermined analog precoding matrix.

In some example embodiments, a carrier frequency of the downlink multiple-input multiple-output system is at or above Terahertz level.

### BRIEF DESCRIPTION OF THE DRAWINGS

Some embodiments will now be described, by way of non-limiting examples, with reference to the accompanying drawings. Throughout drawings and descriptions, similar to substantially same reference number would intend to refer to similar or substantially same elements, messages, operations, or the like.

FIG. 1 illustrates an example downlink MIMO system in an example embodiment.

FIG. 2 illustrates an example process for determining an analog precoding matrix in an example embodiment.

FIG. 3 illustrates an example method for precoding in a downlink MIMO system in an example embodiment.

FIG. 4 illustrates powers of effective channels with different number of RF chains.

FIG. 5 illustrates spectral efficiencies with different number of RF chains.

FIG. 6 illustrates spectral efficiencies with different signal noise ratios.

FIG. 7 illustrates a probability density function of RF utilization rate.

FIG. 8 illustrates a probability density function of RF utilization rate.

### DETAILED DESCRIPTION

The ultra-short wavelength may allow the design of an antenna array including large antenna elements at transceivers, for example to provide a high beamforming gain to compensate pathloss, and multiple data streams may be supported to offer a multiplexing gain and further improve the spectral efficiency (SE) of the system. For example, a hybrid precoding may be adopted in the THz system, where a signal processing procedure may be divided into a digital baseband part followed by an analog radio frequency (RF) band part. In some implementations, the hybrid precoding is based on a fully connected (FC) architecture of analog precoder, which for example may be of power inefficiency since each RF chain needs to connect to all antennal elements. In some implementations, precoding matrices of the digital precoder and the analog precoder are determined and optimized jointly, where optimization problems of the digital precoder and the analog precoder are coupled with each other in the same iterative process, and for example an optimal metric of the communication system (for example, the maximal SE and energy efficiency) may be not obtained.

In one or more example embodiments of this disclosure, the hybrid precoding is based on an AoSA architecture where each RF chain connects to a part of antennas rather than being fully connected to all antennas, so that power consumption may be reduced. Further, in one or more example embodiments, the determination and optimization of analog precoder design and digital precoder design are decoupled, where an analog precoding matrix associated with the analog precoder may be determined and/or optimized independently of a digital precoding matrix associated with the digital precoder, and the digital precoding matrix may be determined and/or optimized based on the determined analog precoding matrix after the determination and/or optimization of the analog precoding matrix. Thus, for example, a better (for example, the highest) power of effective channel and SE may be achieved.

Throughout this disclosure, (⋅)^{T} and (⋅)^{H} denote transpose and conjugate transpose respectively, ∥⋅∥_{F} denotes a Frobenius norm, E(⋅) denotes an expectation, CN(μ,σ²) denotes complex Gaussian vector with mean μ and covariance σ², tr(x) means a trace of x, Diag(x) means to reshape a vector x as a diagonal matrix, (o) denotes the Hadamard product, and [symbol] denotes an integer set.

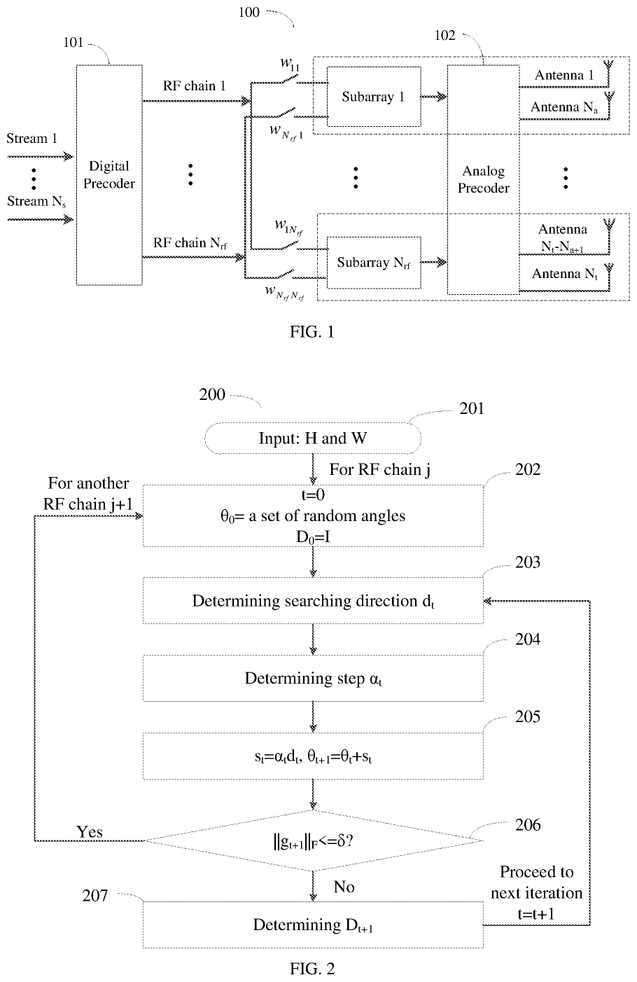

FIG. 1 illustrates an example downlink MIMO system 100 in an example embodiment, which for example may be at least a part of a network node or apparatus such as a base station configured with MIMO. For example, a carrier frequency of the example downlink system 100 may be at or above THz level.

As illustrated in FIG. 1, the example downlink MIMO system 100 may include Nₜ transmitting antennas (antenna 1 to antenna Nₜ), N_{rf} RF chains (RF chain 1 to RF chain N_{rf}), a digital precoder 101 connecting to the RF chains, and an analog precoder 102 between the RF chains and the transmitting antennas. The example downlink MIMO system 100 is configured based on an AoSA architecture where each RF chain connects to a set of subarrays (subarray 1 to subarray N_{rf}), and each subarray may include Nₐ=└Nₜ/N_{rf}┘ antenna elements, where └x┘ denotes the largest integer less than x. As illustrated in FIG. 1, the example downlink MIMO system 100 may be configured to process N_{S} data streams (stream 1 to stream Nₛ), for example to map the data streams to suitable antenna ports.

If a user equipment (UE) implements Nᵣ receiving antennas, a transmitting signal is denoted as X=[x₁, . . . , x_{N}_{ₛ}]^{T} such that E[|xₖ|²]=1 for k=1, . . . , Nₛ, then a receiving signal may be

Y=C_{D}^{H}C_{A}^{H}H(P_{A}oW)P_{D}X+C_{D}^{H}C_{A}^{H}N (1)

where N is a noise vector including Nᵣ elements, each element of N follows a distribution CN(0,σ²). C_{A} is an Nᵣ×N_{rf} analog combiner, which satisfies ∥C_{A}(i,j)∥_{F}²=1/Nᵣ. C_{D} is an N_{rf}×Nₛ digital combiner, which satisfies ∥C_{A}·C_{D}∥_{F}²=1. H represents Nᵣ×Nₜ physical channels.

P_{A} is an Nₜ×N_{rf} analog precoding matrix of the analog precoder 102, which satisfies a constant modulus constraint

∥P_{A}(i,j)∥_{F}²=1/Nₜ (2)

W is a switch matrix whose dimension is NₐN_{rf}×N_{rf}.

$$W = [ \begin{matrix}{w}_{11} , & {w}_{12} , & … , & {w}_{1 {N}_{rf}} \\ {w}_{21} , & {w}_{22} , & … , & {w}_{2 {N}_{rf}} \\ ⋮ & ⋮ & & ⋮ \\ {w}_{{N}_{rf} 1} , & {w}_{{N}_{rf} 2} , & … , & {w}_{{N}_{rf} {N}_{rf}}\end{matrix} ] \qquad ( 3 )$$

where

$${w}_{ij} = \{ \begin{matrix}{1}_{{N}_{a}} , & RF chain j connets to subarray i \\ {0}_{{N}_{a}} , & otherwise\end{matrix} ,$$

that is, wᵢⱼ is a Nₐ×1 dimensional vector with all elements equal to one if RF chain j connects to subarray i, otherwise all of its elements are equal to zero.

P_{D} is a N_{rf}×Nₛ digital precoding matrix of the digital precoder 101, which satisfies the power constraints

∥\tilde{P}_{A}P_{D}∥_{F}²=1 (4)

where

\tilde{P}_{A}=P_{A}oW (5)

Assuming that uniform linear array is implemented at both base station and UE, and if a ray-cluster based spatial channel model is employed, then H may be represented as

$$H = \sqrt{{N}_{r} \cdot {N}_{t}} {\sum }_{l = 1}^{L} {g}_{l} {a}_{r} ( {ϕ}_{l} ) {a}_{t}^{H} ( {θ}_{l} ) \qquad ( 6 )$$

where gₗ,ϕₗ,θₗ represent a complex path gain, an angle of arrival (AoA) and an angle of departure (AoD) of path l, with a total path number being L. aᵣ(⋅),aₜ(⋅) are array response vectors of the receiving and transmitting antenna arrays.

If denoting λ as a wavelength of a carrier frequency, Dₜ=dₜ/λ,Dᵣ=Dᵣ/λ as relative inter-element distances of the transmitting and receiving antenna array, where dₜ,dᵣ are absolute inter-element distances of the transmitting and receiving antenna array, then

$${a}_{t} ( {θ}_{l} ) = {\frac{1}{\sqrt{{N}_{t}}} [ 1 , {e}^{j 2 π {D}_{t} sin ( {θ}_{l} )} , ... , {e}^{j 2 π {D}_{t} ( {N}_{t} - 1 ) sin ( {θ}_{l} )} ]}^{T} \qquad ( 7 )$$

$${a}_{r} ( {ϕ}_{l} ) = {\frac{1}{\sqrt{{N}_{r}}} [ 1 , {e}^{j 2 π {D}_{r} sin ( {ϕ}_{l} )} , ... , {e}^{j 2 π {D}_{r} ( {N}_{r} - 1 ) sin ( {ϕ}_{l} )} ]}^{T} \qquad ( 8 )$$

For designing the analog precoding matrix P_{A} of the analog precoder 102, in some example embodiments, an objective function may be to maximize a power of an effective channel with the constant modulus constraint, for example as follows:

$$( P 1 ) max \{ {‖ H {\tilde{P}}_{A} ‖}_{F}^{2} \} \qquad ( 2 )$$

$$s . t .$$

The objective function of (P1) may be rewritten as the following, so that a (P1) is transformed to (P2) which is a set of individual sub-problems.

$$\begin{matrix}( P 2 ) max \{ {‖ H {\tilde{P}}_{A} ‖}_{F}^{2} \} = \{ {‖ H [ {\tilde{P}}_{A}^{1} , {\tilde{P}}_{A}^{2} , ... {\tilde{P}}_{A}^{{N}_{rf}} ] ‖}_{F}^{2} \} \\ = \{ {\sum }_{j = 1}^{{N}_{rf}} {‖ H {\tilde{P}}_{A}^{j} ‖}_{F}^{2} \}\end{matrix} \qquad ( 2 )$$

$$s . t .$$

where \tilde{P}_{A}^{j} denotes the column j of \tilde{P}_{A}.

Further, (P2) may be transformed into a standard optimization formulation, and each sub-problem of (P2) may be denoted as the following:

$$( P 3 ) min \{ - {‖ H {\tilde{P}}_{A}^{j} ‖}_{F}^{2} \} \qquad ( 2 )$$

$$s . t .$$

With the joint consideration of AoSA architecture for each RF chain, the following equitation may be obtained:

H\tilde{P}_{A}^{j}=H_{eff}P_{eff}^{j} (9)

where P_{eff}^{j} is the set of non-zeros elements of \tilde{P}_{A}^{j}, and H_{eff} is the effective channel matrix composed of columns of H corresponding to non-zeros elements of \tilde{P}_{A}^{j}.

Assuming that the set of non-zeros elements of \tilde{P}_{A}^{j} is K^{j}, and based on the constant modulus constraint (2) and the above equation (9), the following equation may be obtained:

$${P}_{eff}^{j} = \{ \frac{1}{\sqrt{{N}_{t}}} {e}^{j \cdot {θ}_{k}} \vert k = 1 , 2 , ... \vert {K}^{j} \vert \} \qquad ( 10 )$$

When representing H as H=[H₁, H₂, . . . H_{N}_{ₜ}], the following equations may be obtained:

$$\begin{matrix}{‖ {H}_{eff} {P}_{eff}^{j} ‖}_{F}^{2} = ‖ {\sum }_{k = 1}^{\vert {K}^{j} \vert} \frac{1}{\sqrt{{N}_{t}}} {H}_{k} {e}^{j \cdot {θ}_{k}} ‖ \\ = {\sum }_{m = 1}^{\vert {K}^{j} \vert - 1} {\sum }_{n = m + 1}^{\vert {K}^{j} \vert} \frac{{A}_{m , n} cos ( {θ}_{m} - {θ}_{n} - {B}_{m , n} )}{{N}_{t}}\end{matrix} \qquad ( 11 )$$

where A_{m,n} is an amplitude of Hₘ^{H}Hₙ, and B_{m,n} is an angle of Hₘ^{H}Hₙ.

Since Nₜ is a constant variable, (P4) may be transformed into (P4) as the following.

$$( P 4 ) min \{ {\sum }_{m = 1}^{\vert {K}^{j} \vert - 1} {\sum }_{n = m + 1}^{\vert {K}^{j} \vert} - {A}_{m , n} cos ( {θ}_{m} - {θ}_{n} - {B}_{m , n} ) \}$$

Based on the above deduction, the non-convex constraint (2) of (P3) is removed in (P4). Moreover, A_{m,n} and B_{m,n} are known variables given H. Thus, (P4) is a non-constrained optimization problem only related to the angle of P_{eff}^{j}.

Further, if denoting the set of non-zeros elements of \tilde{P}_{A}^{j} at iteration t as Kₜ^{j}, from the above equation (10), we may have

θₜ=[θₜ¹,θₜ², . . . , θₜ^{|K}^{ₜ}^{^{j}}^{|}]^{T} (12)

Then, for (P4), an objective function at an iteration t may be

$${f}_{t} = {\sum }_{m = 1}^{\vert {K}_{t}^{j} \vert - 1} {\sum }_{n = m + 1}^{\vert {K}_{t}^{j} \vert} - {A}_{m , n} cos ( {θ}_{t}^{m} - {θ}_{t}^{n} - {B}_{m , n} ) \qquad ( 13 )$$

and a gradient function at the iteration t with respect to m may be

$${g}_{t} ( m ) = {\sum }_{n = 1 , n \neq m}^{\vert {K}_{t}^{j} \vert} {ζ}_{m , n} {A}_{m , n} sin ( {θ}_{t}^{m} - {θ}_{t}^{n} - {B}_{m , n} ) \qquad ( 14 )$$

where

$${ζ}_{m , n} = \{ \begin{matrix}1 , & m > n \\ - 1 , & m < n\end{matrix} ,$$

and the gradient function at the iteration t is

gₜ=[gₜ(1),gₜ(2), . . . , gₜ(|Kₜ^{j})]^{T} (15)

Then, given H and W, for the RF chain j, at an initial iteration t=0, θₜ (the set of non-zeros elements of the column j of \tilde{P}_{A} at iteration t) may be initialized as a set of random angles.

Further, for the RF chain j, at any iteration t, a search direction may be determined as

dₜ=−Dₜgₜ (16)

where Dₜ is an approximation of an inverse of a Hessian matrix of the objective function ƒₜ at the current iteration t, and may be initialized as an identity matrix I at the initial iteration (t=0), and a step αₜ may be determined or updated for example by one dimension search method such as Wolfe-Powell method, and may satisfy the following conditions:

ƒₜ₊₁≤ƒₜ+αₜρ₁gₜ^{T}dₜ

gₜ₊₁^{T}dₜ≥ρ₂gₜ^{T}dₜ (17)

where ρ₁ and ρ₂ are two random variables which satisfy ρ₁∈(0,0.5) and ρ₂∈(ρ₁,1).

Then, a phase difference sₜ between the next iteration t+1 and the current iteration t may be determined as sₜ=αₜdₜ, and θₜ₊₁ (the set of non-zeros elements of the column j of \tilde{P}_{A} at the next iteration t₊₁) may be determined as θₜ₊₁=θₜ+sₜ.

If ∥gₜ₊₁∥_{F}≤δ where δ is a positive constant, the iteration for the RF chain j may be stopped, and the column j of \tilde{P}_{A} (further, a column j of precoding matrix P_{A} of the analog precoder 102) may be determined. Then, an iteration process may be performed for another RF chain (for example the RF chain j+1).

If ∥gₜ₊₁∥_{F}>δ, Dₜ₊₁ (an approximation of an inverse of a Hessian matrix of the objective function ƒₜ₊₁ at the next iteration t+1) may be determined based on the following equation:

$${D}_{t + 1} = \{ \begin{matrix}( I - \frac{{s}_{t} {y}_{t}^{T}}{{y}_{t}^{T} {s}_{t}} ) {D}_{t} ( I - \frac{{y}_{t} {s}_{t}^{T}}{{y}_{t}^{T} {s}_{t}} ) + \frac{{s}_{t} {s}_{t}^{T} Q ( w )}{{( {y}_{t}^{T} {s}_{t} )}^{2}} , & if \frac{{y}_{t}^{T} {s}_{t}}{{‖ {s}_{t} ‖}_{F}} \geq ε {‖ {g}_{t} ‖}_{F} \\ {D}_{t} , & else\end{matrix} \qquad ( 18 )$$

where ε is a positive constant, Q(w) is an updated coefficient which is related to the weighted coefficient w∈[0,1], for example Q(w)=wyₜ^{T}sₜ+2(1−w)(ƒₜ₊₁−ƒₜ−gₜ^{T}sₜ). Then, the next iteration t+1 for the RF chain j may be proceeded to.

Thus, after a completion of all iterations for all RF chains, the analog precoding matrix of the analog precoder 102 may be determined, which process may be independent of the determination of the digital precoding matrix of the digital precoder 101 or the design of the digital precoder 101.

FIG. 2 illustrates an example process 200 for determining the analog precoding matrix of the analog precoder 102 in an example embodiment.

As illustrated in FIG. 2, inputs 201 of the example process 200 may include H and W. Then, for the RF chain j among the N_{rf} RF chains in the example downlink MIMO system 100, at least one iteration may be performed to determine a column of the analog precoding matrix corresponding to the RF chain j.

As illustrated in FIG. 2, at an operation 202, an initialization may be performed for the at least one iteration for the RF chain j, where a value of an iteration counter t may be initialized as 0 (t=0), θ₀ (the set of non-zeros elements of the column j of \tilde{P}_{A} at the iteration t=0) may initialized as a set of random angles, and D₀ (an approximation of an inverse of a Hessian matrix of the objective function ƒₜ at the iteration t=0).

Then, a search direction dₜ at the iteration t for the RF chain j may be determined for example based on the above equation (16) in an operation 203, a step αₜ at the iteration t for the RF chain j may be determined for example based on above conditions (17) in an operation 204. Then, in an operation 205, a phase difference sₜ between the next iteration t+1 and the current iteration t may be determined as sₜ=αₜdₜ, and θₜ₊₁ (the set of non-zeros elements of the column j of \tilde{P}_{A} at the next iteration t₊₁) may be determined as θₜ₊₁=θₜ+sₜ.

Then, in an operation 206, it is checked whether ∥gₜ₊₁∥_{F}≤δ. If the operation 206 returns “Yes” (∥gₜ₊₁∥_{F}≤δ), as illustrated in FIG. 2, the example process 200 may proceed to the operation 202 for another RF chain (for example, RF chain j+1).

If the operation 206 returns “No” (∥gₜ₊₁∥_{F}>δ), an operation 207 may performed at the iteration t for the RF chain j, to determine Dₜ₊₁ (an approximation of an inverse of a Hessian matrix of the objective function ƒₜ₊₁ at the next iteration t+1) based on at least one of Dₜ, the phase difference sₜ, and the gradient difference yₜ=gₜ₊₁−gₜ between the current iteration t and the next iteration t+1. For example, the operation 207 may be performed based on the above equation (18). Then, the example process 200 may proceed to the operation 203 by updating t as t+1, to perform the next iteration for the RF chain j.

After the analog precoding matrix of the analog precoder 102 is determined, the digital precoding matrix of the digital precoder 101 may be determined based on the determined analog precoding matrix by using any suitable method.

For example, after the completion of the example process 200 through which \tilde{P}_{A} corresponding to the analog precoding matrix P_{A} of the analog precoder 102 is determined, the digital precoding matrix P_{D} of the digital precoder 101 may be determined by using a single value deduction (SVD) method, for example as follows:

P_{D}=V·Γ (19)

where V is the first Nₛ columns of a right singular matrix from the SVD of the effective channel H\tilde{P}_{A}, and Γ is an Nₛ×Nₛ dimensional water filling power allocation matrix.

Further, the digital precoding matrix P_{D} may be normalized as:

P_{D}=P_{D}/∥\tilde{P}_{A}P_{D}∥_{F} (20)

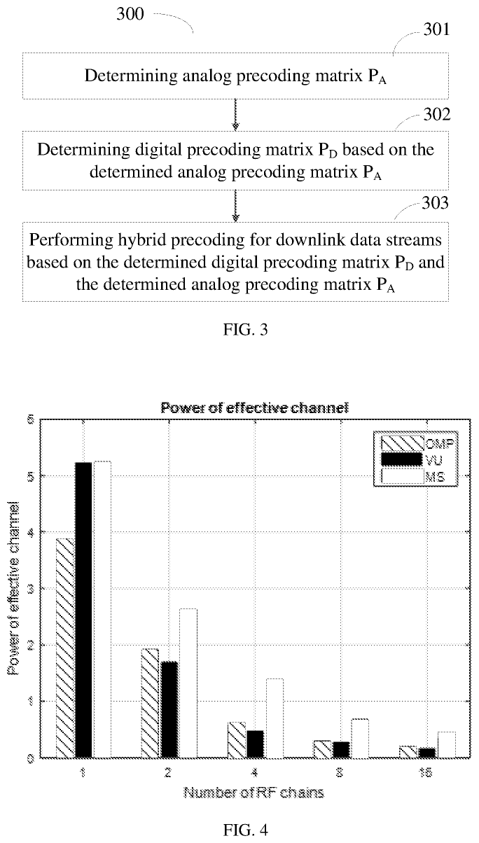

FIG. 3 illustrates an example process 300 for precoding in the example downlink MIMO system 100 in an example embodiment.

In an operation 301, the analog precoding matrix analog precoding matrix P_{A} (or \tilde{P}=P_{A}oW) of the analog precoder 102 may be determined for the N_{rf} RF chains in the example downlink MIMO system 100. For example, in the operation 301, the above example process 200 may be performed.

Then, after the analog precoding matrix analog precoding matrix P_{A} (or \tilde{P}_{A}=P_{A}oW) of the analog precoder 102 is determined in the operation 301, in an operation 302, the digital precoding matrix P_{D} of the digital precoder 101 may be determined based on the determined analog precoding matrix P_{A} (or \tilde{P}_{A}=P_{A}oW) of the analog precoder 102. For example, in the operation 302, the digital precoding matrix P_{D} of the digital precoder 101 may be determined by using the SVD method, for example based on the above equations (19) and (20).

Then, in an operation 303, the determined digital precoding matrix P_{D} of the digital precoder 101 and the determined analog precoding matrix P_{A} (or \tilde{P}_{A}=P_{A}oW) of the analog precoder 102 may be used to perform a hybrid precoding for the N_{S} data streams. Thus, the N_{S} data streams may be mapped to suitable antenna ports.

Consider SE as a metric of the above example process 300, according Shannon's theory, the SE of a stream s may be Rₛ=log(1+SNRₛ) where SNRₛ is a signal noise ratio of the stream s, and the SE of the above example process 300 may be

$$R = {\sum }_{s} {R}_{s} .$$

In a simulation, the following parameters are selected: Nₜ=256, Nᵣ=4, N_{rf}=[1,2,4,8,16], Nₛ=min(min(Nₜ,Nᵣ),N_{rf}) where min( ) is an operation for obtaining a minimum value, δ=0.001, ε=0.1, w=0.9, ρ₁=0.25, ρ₂=0.75, and SNR=[0,30] dB.

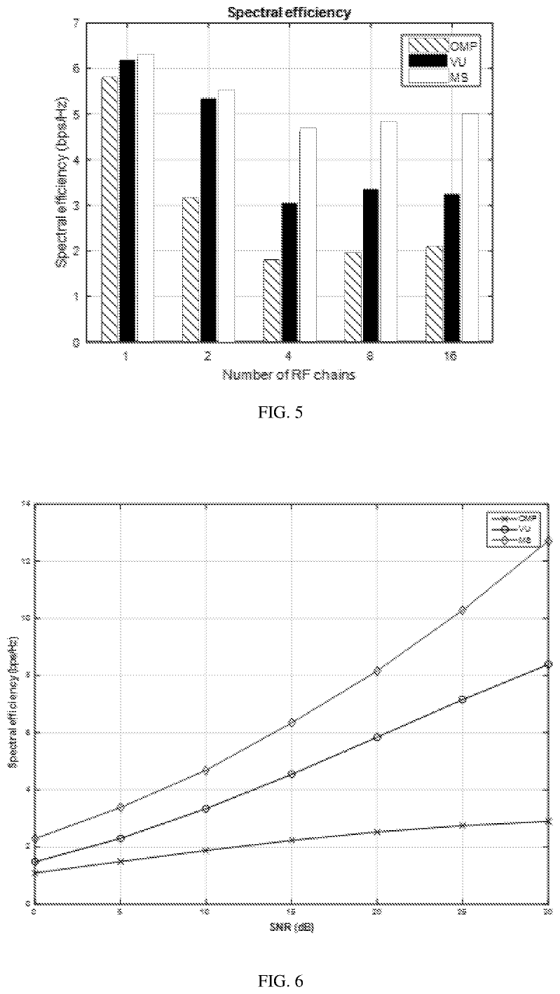

Then, for example in a case of SNR=10 dB, the powers of effective channels with different number of RF chains are illustrate in FIG. 4, and the spectral efficiencies with different number of RF chains are illustrate in FIG. 5, where OMP is an orthogonal matching pursuit (OMP) hybrid precoding method which is an example of hybrid precoding method based on FC architecture, VU is a vectorization plus unitary (VU) hybrid precoding method which is another example of hybrid precoding method where optimization problems of the digital precoder and the analog precoder are coupled with each other in the same iterative process, and MS is the example process 300. It can be seen that the example process 300 for precoding in the example embodiment achieves higher power of effective channel and SE compared with OMP and VU.

FIG. 6 illustrates SEs with different SNRs in a case where N_{rf}=8. As illustrated in FIG. 6, the SEs of all curves increase when SNR increases, and compared with OMP and VU, the example process 300 for precoding in the example embodiment may achieves higher power of effective channel and SE at any SNR equipped with any number of RF chains.

It is appreciated that the implementations of the operations 301 and 302 in the above example process 300 are not limited to the above examples, and the metric is not limited to the power of effective channel and SE.

For example, if opening a RF chain cannot provide sufficient transmission throughput, this RF chain may be closed to save power. Further, the transmission rank number may be adaptive to the received SNR in order to provide spatial diversity or multiplexing gain. For example, the transmission rank number may equal to 1 if the received SNR is low since spatial diversity can improve the received SNR to provide good coverage. While the transmission rank number may equal to the maximal rank number if the received SNR is high since spatial multiplexing can improve the transmission throughput. Thus, in some example embodiments, the analog precoder 102 and the digital precoder 101 may be configured to optimize a RF chain utilization rate which is defined as a ratio of the SE by using the current RF chain number to the SE by using the maximal RF chain number.

For example, the inputs provided to the example process 300 may include information associated with physical channels H, the switch matrix W, a predetermined set of candidate analog precoding matrices P_{A}^{S}, and a RF chain utilization rate threshold γ.

For example, before applying the example process 300, the optimal transmission rank number Nₛ may be determined by utilizing a rank adaptation technology, and the optimal digital precoding matrix P* of the digital precoder 101 may be determined by using SVD of the physical channels H. For example, P* may be the first Nₛ columns of the right singular matrix from the SVD of the physical channels H.

Then, in the operation 301, for each RF chain, a column of P_{A}^{S} corresponding to the RF chain may be selected. The selection criteria may include, but not limited to, one or more of: a column with the maximal received power, a column with the maximal SNR, a column with the nearest spatial angle, a column with the minimal latency, and so on. Then, the selected columns may be combined and sorted according to a descending order of degrees that respective selected columns match to H, and thus an available analog precoding matrix P_{A}^{A} of the analog precoder 102 may be obtained in the operation 301.

In the operation 302, the SE of the current RF chain number may be calculated where the RF chain number I_{rf} increases from Nₛ to N_{rf}, and may be denoted as [R_{N}_{ₛ},R_{N}_{ₛ}₊₁, . . . , R_{N}_{_{rf}}]. Then, an unnormalized digital precoding matrix of the digital precoder 101 may be determined by least square algorithm P_{D}=(P_{AC}^{H}P_{AC})⁻¹P_{AC}^{H}P*. In another example, the unnormalized digital precoding matrix of the digital precoder 101 may also be determined by a unitary matrix algorithm P_{D}=UV^{H} where U and V are the left and right singular matrix from the SVD of P*P_{AC}. Further, the normalized digital matrix of the digital precoder 101 may be P_{D}=P_{D}/∥P_{AC}P_{D}∥_{F}.

Further, in some example embodiments, for each I_{rf}∈[Nₛ,N_{rf}], the SE of the current RF chain number I_{rf} may be evaluated as

$${R}_{{I}_{rf}} = log 2 ( \vert {I}_{{N}_{r}} + \frac{1}{{σ}^{2}} {HP}_{AC} {{P}_{D} ( {HP}_{AC} {P}_{D} )}^{H} \vert ) .$$

For each R_{I}_{_{rf}} where I_{rf}∈[Nₛ,N_{rf}], R_{I}_{_{rf}}/R_{N}_{_{rf}} may be calculated, and the smallest value of I_{rf}, which is denoted as I* and satisfies R_{I}*/R_{N}_{_{rf}}≥γ, may be determined. Then, optimal analog and digital precoding matrices may be selected corresponding to I*.

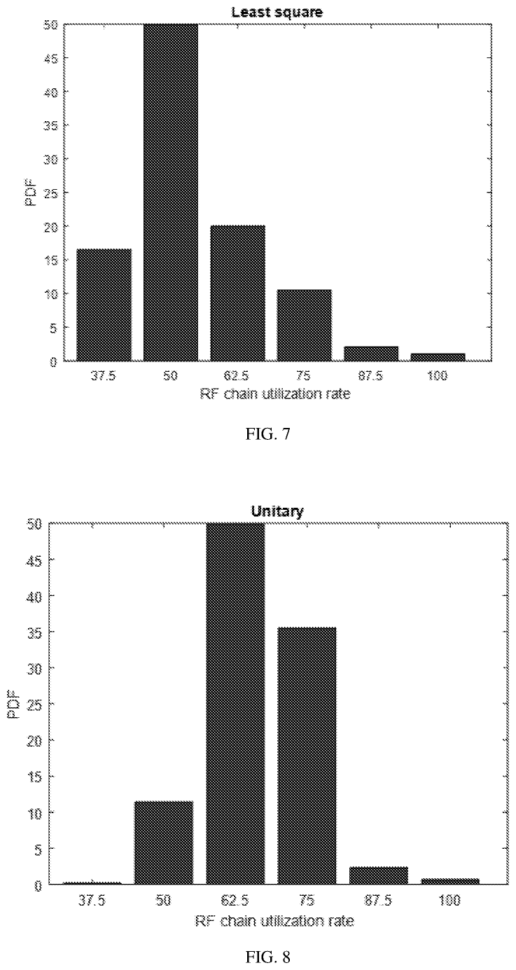

Let Nₜ=256, Nᵣ=4, N_{rf}=8, γ=0.9, and SNR is in the range 0 to 50 dB. FIG. 7 illustrates a probability density function (PDF) of RF utilization rate in a case where the digital precoding matrix is determined based on the least square algorithm, and FIG. 8 illustrates a PDF of RF utilization rate in a case where the digital precoding matrix is determined based on the unitary matrix algorithm. It can be seen that an average RF chain utilization rate in a case of least square algorithm (Least square) is 54.35%, which means only 54.35% RF chains are needed to open so that 90% SE can be achieved, compared with a case of opening all RF chains. Similarly, the average RF chain utilization rate in a case of the unitary matrix algorithm (Unitary) is 66.3%. Thus, great energy may be saved.

In one or more example embodiments, the hybrid precoding is based on the AoSA architecture so that power consumption may be reduced. Further, the determination and optimization of analog precoder 102 and digital precoder 101 are decoupled, where an analog precoding matrix associated with the analog precoder 102 may be determined and/or optimized independently of a digital precoding matrix associated with the digital precoder 101, and the digital precoding matrix may be determined and/or optimized based on the determined analog precoding matrix after the determination and/or optimization of the analog precoding matrix. Thus, the design of analog precoder 102 and digital precoder 101 in a downlink MIMO system may be simplified. Further, according to simulation experiment results, better power of the effective channel, better SE, and/or better energy efficiency may be achieved through solutions in one or more example embodiments of this disclosure.

Another example embodiment may relate to computer program codes or instructions which may cause an apparatus (for example, a base station in a downlink MIMO system based on AoSA architecture) to perform at least respective methods described above. Another example embodiment may be related to a computer readable medium having such computer program codes or instructions stored thereon. In some example embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Further, modifiers such as “first”, “second” and so on throughout the description and claims are generally intended to distinguish different elements, operations, and so on, rather than emphasizing any importance, specific sequences, specific priorities, specific elements, and so on.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of some example embodiments described above can be combined to provide further embodiments. The accompanying claims and their equivalents are intended to cover such forms or modifications as would fall within the scope and spirit of the disclosure.

1. A method for precoding in a downlink multiple-input multiple-output system based on an array of subarray architecture comprising:
determining an analog precoding matrix for a plurality of radio frequency chains in the downlink multiple-input multiple-output system;
determining a digital precoding matrix for the plurality of radio frequency chains based on the determined analog precoding matrix; and
performing a hybrid precoding for a plurality of downlink data streams based on the determined digital precoding matrix and the determined analog precoding matrix.

2. The method of claim 1 wherein the determination of the analog precoding matrix comprises:
for a radio frequency chain of the plurality of radio frequency chains, determining a column of the analog precoding matrix corresponding to the radio frequency chain in at least one iteration based on a plurality of physical channels associated with the downlink multiple-input multiple-output system and a switch matrix in the downlink multiple-input multiple-output system.

3. The method of claim 2 wherein in a current iteration of the at least one iteration, the determination of the analog precoding matrix comprises:
determining a first approximation of an inverse of a Hessian matrix of a first objective function for the current iteration;
determining angles of departure corresponding to the column based on the first approximation; and
determining a second approximation of an inverse of a Hessian matrix of a second objective function for a next iteration of the at least one iteration through matrix plus and multiplication operations based on the first approximation, a phase difference between the current iteration and the next iteration, and a gradient difference between the current iteration and the next iteration.

4. The method of claim 1 wherein the determination of the analog precoding matrix comprises:
for a radio frequency chain of the plurality of radio frequency chains, determining a column of the analog precoding matrix corresponding to the radio frequency chain in at least one iteration based on a subset of a predetermined analog precoding matrix.

5. The method of claim 1, wherein a carrier frequency of the downlink multiple-input multiple-output system is at or above Terahertz level.

6. An apparatus for precoding in a downlink multiple-input multiple-output system based on an array of subarray architecture, comprising:
a plurality of transmitting antennas;
a plurality of radio frequency chains;
an analog precoder between the plurality of radio frequency chains and the plurality of transmitting antennas; and
a digital precoder connecting to the plurality of radio frequency chains,
an analog precoding matrix associated with the analog precoder being determined independently of a digital precoding matrix associated with the digital precoder, and the digital precoding matrix being determined based on the determined analog precoding matrix.

7. The apparatus of claim 6 wherein the determination of the analog precoding matrix comprises:
for a radio frequency chain of the plurality of radio frequency chains, determining a column of the analog precoding matrix corresponding to the radio frequency chain in at least one iteration based on a plurality of physical channels associated with the downlink multiple-input multiple-output system and a switch matrix in the downlink multiple-input multiple-output system.

8. The apparatus of claim 7 wherein in a current iteration of the at least one iteration, the determination of the analog precoding matrix comprises:
determining a first approximation of an inverse of a Hessian matrix of a first objective function for the current iteration;
determining angles of departure corresponding to the column based on the first approximation; and
determining a second approximation of an inverse of a Hessian matrix of a second objective function for a next iteration of the at least one iteration through matrix plus and multiplication operations based on the first approximation, a phase difference between the current iteration and the next iteration, and a gradient difference between the current iteration and the next iteration.

9. The apparatus of claim 6 wherein the determination of the analog precoding matrix comprises:
for a radio frequency chain of the plurality of radio frequency chains, determining a column of the analog precoding matrix corresponding to the radio frequency chain in at least one iteration based on a subset of a predetermined analog precoding matrix.

10. The apparatus of claim 6, wherein a carrier frequency of the downlink multiple-input multiple-output system is at or above Terahertz level.

11. A non-transitory computer readable medium comprising instructions stored thereon for causing an apparatus for precoding in a downlink multiple-input multiple-output system based on an array of subarray architecture to perform:
determining an analog precoding matrix for a plurality of radio frequency chains in the downlink multiple-input multiple-output system;
determining a digital precoding matrix for the plurality of radio frequency chains based on the determined analog precoding matrix; and
performing a hybrid precoding for a plurality of downlink data streams based on the determined digital precoding matrix and the determined analog precoding matrix.

12. The non-transitory computer readable medium of claim 11 wherein the determination of the analog precoding matrix comprises:
for a radio frequency chain of the plurality of radio frequency chains, determining a column of the analog precoding matrix corresponding to the radio frequency chain in at least one iteration based on a plurality of physical channels associated with the downlink multiple-input multiple-output system and a switch matrix in the downlink multiple-input multiple-output system.

13. The non-transitory computer readable medium of claim 12 wherein in a current iteration of the at least one iteration, the determination of the analog precoding matrix comprises:
determining a first approximation of an inverse of a Hessian matrix of a first objective function for the current iteration;
determining angles of departure corresponding to the column based on the first approximation; and
determining a second approximation of an inverse of a Hessian matrix of a second objective function for a next iteration of the at least one iteration through matrix plus and multiplication operations based on the first approximation, a phase difference between the current iteration and the next iteration, and a gradient difference between the current iteration and the next iteration.

14. The non-transitory computer readable medium of claim 11 wherein the determination of the analog precoding matrix comprises:
for a radio frequency chain of the plurality of radio frequency chains, determining a column of the analog precoding matrix corresponding to the radio frequency chain in at least one iteration based on a subset of a predetermined analog precoding matrix.

15. The non-transitory computer readable medium of claim 11, wherein a carrier frequency of the downlink multiple-input multiple-output system is at or above Terahertz level.
